(19) United States
(12) Patent Application Publication
(10) Pub. No.: US 2019/0039733 A1
(43) Pub. Date: Feb. 7, 2019

(54) RACK

(71) Applicant: ISRAEL AEROSPACE INDUSTRIES LTD., Lod (IL)

(72) Inventor: Abraham HAYAT, Ganey Tikva (IL)

(21) Appl. No.: 15/580,852

(22) PCT Filed: Jun. 7, 2016
(86) PCT No.: PCT/IL2016/050589

§ 371 Date: Dec. 8, 2017

(30) Foreign Application Priority Data
Jun. 11, 2015 (IL) 239348

(51) Int. Cl. B64D 1/06; F16B 45/02

(52) U.S. Cl. CPC B64D 1/06; F16B 45/02

(57) ABSTRACT

An ejector rack is provided for releasably supporting a store, and includes a housing, having a lug engaging and releasing mechanism operative for selectively and releasably engaging the lug, and movable between a lug engaging position and a lug releasing position. The housing also includes a locking and unlocking mechanism actuable between a locking position, for reversibly locking the lug engaging and releasing mechanism in the lug engaging position, and an unlocking position, for enabling the lug engaging and releasing mechanism to adopt the lug releasing position. The housing also includes an actuation system for reversibly actuating the locking and unlocking mechanism, which is operative for supporting part of a load applied by the store via the lug to the lug engaging and releasing mechanism in the lug engaging position. Also provided is an ejector rack for releasably supporting, and selectively ejecting forcibly, a store therefrom, and includes an ejector system having at least one ejection module, operative for storing elastic potential energy therein and for utilizing the stored potential energy for forcibly ejecting the store when the store is released from the ejector rack.

### TECHNOLOGICAL FIELD

The presently disclosed subject matter relates to devices for carrying and releasing stores from a vehicle, in particular to ejector racks for carrying and releasing a store with respect to an air vehicle. The presently disclosed subject matter also relates to devices also for forcibly ejecting released stores from a vehicle, in particular to ejector racks for forcibly ejecting a released store with respect to an air vehicle.

### BACKGROUND ART

References considered to be relevant as background to the presently disclosed subject matter include U.S. Pat. No. 4,050,656.

Acknowledgement of the above references herein is not to be inferred as meaning that these are in any way relevant to the patentability of the presently disclosed subject matter.

### BACKGROUND

Stores, such as for example bombs and missiles, are commonly carried by air vehicles, with a requirement to enable the stores to be released when required by the pilot or other aircrew. Conventionally, such carrying and release functions are provided by ejector racks, in which actuation thereof to release the stores is by ignition of gas cartridges.

By way of non-limiting example, U.S. Pat. No. 4,050,656 discloses an ejector rack that is attachable to an aircraft and is for supporting and selectively releasing and/or ejecting a store that is carried internal of the aircraft, i.e., in a bomb bay. The store can be released from the ejector rack, and from the aircraft, in either of two ways, namely: by pushing on a manually operated release handle; or, by forced ejection, the only way used during flight of the aircraft. Forced ejection is achieved by sending an electrical impulse to either both of two cartridges in the breech of the ejector rack, igniting the cartridge(s). Gas is generated thereby; and, the resultant pressure that is built up in a gas system in the rack provides force that acts upon an unlocking piston, causing the piston to move out of its “locked” position. In turn, the moving piston provides a force on a slide, rotating a latch that allows the main linkage bellcrank to rotate and thus to open two hooks which are holding the store, thereby releasing the suspended store. Concurrently, gas pressure is manifolded to two sway brace ejection piston cylinders, and the ejection pistons therein are forcefully extended, causing positive and forcible ejection of the store by the ejection pistons.

### GENERAL DESCRIPTION

According to a first aspect of the presently disclosed subject matter, there is provided an ejector rack for releasably supporting a store, the store having at least one lug for enabling removable engagement of the store with respect to the ejector rack, the ejector rack comprising:
a housing, including:
a lug engaging and releasing mechanism configured for selectively and releasably engaging the lug, and movable between a lug engaging position and a lug releasing position;
a locking and unlocking mechanism actuable between a locking position, for reversibly locking said lug engaging and releasing mechanism in said lug engaging position, and an unlocking position, for enabling the lug engaging and releasing mechanism to adopt said lug releasing position;
an actuation system for reversibly actuating said locking and unlocking mechanism;
wherein the locking and unlocking mechanism is configured, in operation of the ejector rack, for supporting part of a load applied by the store via the lug to the lug engaging and releasing mechanism in said lug engaging position.

For example, said part of the load is about 50%±10% of the load.

For example, in the lug engaging position the lug engaging and releasing mechanism is in load bearing contact with the locking and unlocking mechanism.

Additionally or alternatively, for example, in the locking position said locking and unlocking mechanism are geometrically locked via the load.

Additionally or alternatively, for example, said lug engaging and releasing mechanism comprises a first kinematic chain, comprising a stressed link pivotably connected to a hook element via a first pin, wherein the stressed link is further pivotably mounted to said housing at a fixed first pivot axis, and the hook element is pivotably mounted to the housing at a fixed second pivot axis. For example, said hook element comprises a C- or U-shaped engagement portion, configured for engaging said lug when pivoted about the second pivot axis to an engagement position, and for disengaging from the lug when pivoted away from the engagement position to a released position, the hook element further comprising an extension having a first abutment surface and a second abutment surface generally inclined to one another, and joined together via a rounded lateral edge, the extension projecting in a direction towards the locking and unlocking mechanism. Additionally or alternatively, for example, said stressed link comprises a free end at said first pin, said free end being reciprocably displaceable in a radial direction with respect to said first pivot axis, and wherein said stressed link is pre-stressed to bias said free end in a direction towards said first pivot axis. Additionally or alternatively, for example, said first kinematic chain operates to provide a first stable position and a second stable position, different from said first stable position, wherein in each one of said first stable position and said second stable position are such as to minimize a potential energy of said stressed link, and in which said first pin is at a respective maximum distance from an imaginary line joining said first pivot axis to said second pivot axis. For example, in said first stable position said first pin is on one side of said imaginary line, and said hook element is pivoted to the engagement position, enabling engagement of the lug, and wherein in the second stable position said first pin is side of said imaginary line and said hook element is pivoted in an opposed direction to the release position, enabling release of the lug if previously engaged thereto.

Additionally or alternatively, for example, said locking and unlocking mechanism is configured to function as a toggle mechanism, wherein a relatively small force applied thereto maintains said locking and unlocking mechanism at the locked position while concurrently enabling a much larger force corresponding to said load to be resisted by said locking and unlocking mechanism.

Additionally or alternatively, for example, said locking and unlocking mechanism comprises a second kinematic chain comprising: a first link pivotably connected to an anvil via a second pin and pivotably connected to a second link via a third pin, wherein said anvil pivotably is mounted to said housing at a fixed third pivot axis, and said second link is pivotably mounted to said housing at a fixed fourth pivot axis, and wherein said anvil is pre-stressed to provide said small force. Additionally or alternatively, for example, said anvil is pre-stressed by a torsion spring to provide said small force. Additionally or alternatively, for example, the second kinematic chain comprises a roller freely rotatable about said third pin, and wherein said roller is in abutting contact alternately with said first abutment surface or said second abutment surface. For example, in said locking position, said engagement portion is in said engagement position, said roller is in abutting contact with said first abutting surface and in load bearing contact therewith, and capable of supporting said part of the load applied by the store via the lug, and wherein said anvil is prestressed to urge said second kinematic chain towards and abut a physical stop provided in the casing, in said locking position.

Additionally or alternatively, for example, a remainder of said load is supported at said first pin. For example, a remainder of said load is symmetrically supported at said first pin and at said roller. For example, in said unlocking position, said anvil is selectively pivoted about said third pivot axis such that said second kinematic chain is urged away from said physical stop, sufficiently for the second kinematic chain to adopt a position that is not capable of supporting said part of the load applied by the store via the lug, enabling said roller to come into abutting contact with said second abutting surface while concurrently said engagement portion pivots to said release position, allowing release of the lug if previously engaged therein. For example, applying a pivoting force to said engagement portion by a lug to pivot the engagement portion to the engagement position automatically results in the second kinematic chain adopting the locking position.

Additionally or alternatively, for example, said actuation system for reversibly actuating said locking and unlocking mechanism comprises a bellcrank pivotably mounted to said housing at a fixed fifth pivot axis, the bellcrank having a long arm and a short arm each extending radially away from said fifth pivot axis, said actuation system further comprising an actuator coupled to said long arm and configured for selectively reversibly pivoting said bellcrank about said fifth pivot axis to thereby reversibly move said short arm between a first position and a second position, to thereby reversibly actuate said locking and unlocking mechanism. For example, moving said short arm between said first position and said second position causes said anvil to pivot about said third pivot axis such that said second kinematic chain is urged away from said physical stop, sufficiently for the second kinematic chain to adopt a position that is not capable of supporting said part of the load applied by the store via the lug. Additionally or alternatively, for example, said actuation system comprises an electrically powered motor comprising a shaft turned thereby, and further comprising a shuttle pivotably mounted top said long arm and coupled to the shaft, such that rotation of the shaft in one or another direction causes displacement of the shuttle, resulting in pivoting of said bellcrank about said fifth pivot axis in one or another direction, respectively.

Additionally or alternatively, for example, the ejector rack is further for selectively ejecting forcibly the store therefrom, the ejector rack comprising an ejector system comprising at least one ejection module, each ejection module configured for storing elastic potential energy therein, and for utilizing the stored potential energy for forcibly ejecting the store when the store is released from the ejector rack. For example, each ejection module comprises a plunger element reciprocably movable with respect to a casing and comprising at least one elastic element therebetween, the plunger element being selectively retractable with respect to the casing to any one of a plurality of retracted positions up to a maximum retracted position, wherein at each said position the at least one elastic element is progressively compressed storing therein said potential energy. For example, said at least one elastic element comprises at least one helical spring.

According to the first aspect of the presently disclosed subject matter, there is also provided an ejector rack for releasably supporting a store, and includes a housing, having a lug engaging and releasing mechanism operative for selectively and releasably engaging the lug, and movable between a lug engaging position and a lug releasing position. The housing also includes a locking and unlocking mechanism actuable between a locking position, for reversibly locking the lug engaging and releasing mechanism in the lug engaging position, and an unlocking position, for enabling the lug engaging and releasing mechanism to adopt the lug releasing position. The housing also includes an actuation system for reversibly actuating the locking and unlocking mechanism, which is operative for supporting part of a load applied by the store via the lug to the lug engaging and releasing mechanism in the lug engaging position.

According to a second aspect of the presently disclosed subject matter, there is provided an ejector rack for releasably supporting, and selectively ejecting forcibly, a store therefrom, the store having at least one lug for enabling removable engagement of the store with the ejector rack, the ejector rack comprising an ejector system comprising at least one ejection module, each ejection module configured for storing elastic potential energy therein, and for utilizing the stored potential energy for forcibly ejecting the store when the store is released from the ejector rack.

For example, each ejection module comprises a plunger element reciprocably movable with respect to a casing and comprising at least one elastic element therebetween, the plunger element being selectively retractable with respect to the casing to any one of a plurality of retracted positions up to a maximum retracted position, wherein at each said position the at least one elastic element is progressively compressed storing therein said potential energy. For example, said at least one elastic element comprises at least one helical spring.

According to the second aspect of the presently disclosed subject matter, there is also provided an ejector rack for ejector rack for releasably supporting, and selectively ejecting forcibly, a store therefrom, and includes an ejector system having at least one ejection module, operative for storing elastic potential energy therein and for utilizing the stored potential energy for forcibly ejecting the store when the store is released from the ejector rack.

According to a third aspect of the presently disclosed subject matter, there is provided an air vehicle comprising at least one ejector rack as defined according to the first aspect of the presently disclosed subject matter.

According to a fourth aspect of the presently disclosed subject matter, there is provided a method for releasably supporting a store, the store having at least one lug, the method comprising:
(a) providing at least one ejector rack as defined according to the first aspect of the presently disclosed subject matter; and
(b) engaging the lug with respect to the lug engaging and releasing mechanism to thereby urge the locking and unlocking mechanism to the locking position.

For example, the method further comprises:
(c) selectively operating the actuation system to thereby actuate said locking and unlocking mechanism to enable the locking and unlocking mechanism to adopt the unlocking position, thereby enabling the lug engaging and releasing mechanism to release the lug therefrom.

Additionally or alternatively, for example, in step (b), a plurality of said ejection modules are in a pre-stressed condition and in abutment with the engaged stores.

For example, in step (c) said plurality of said ejection modules forcibly eject the stores from the ejector rack.

A feature of at least one example of the presently disclosed subject matter is that a relatively low powered electrical motor can be used for releasing a relatively large load.

Another feature at least one example of the presently disclosed subject matter is that such a suspension and release device can be provided at a small scale, for example for use with small air vehicles, for example some types of UAV's.

Another feature at least one example of the presently disclosed subject matter is that such a suspension and release device can obviate the necessity for the release to be driven by the ignition of gas cartridges.

Another feature at least one example of the presently disclosed subject matter is that the suspension and release device uses the actual weight of the stores being supported thereby, together with a geometrical lock, to maintain the stores engaged.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 shows in front/bottom/side isometric view a suspension and release device according to a first example of the presently disclosed subject matter.

FIG. 2 shows in front/bottom/side isometric view the example of FIG. 1 with a side panel removed.

FIG. 3 shows in transverse cross-sectional view the example of FIG. 1, taken along section J-J in FIG. 1.

FIG. 4 shows in partial side view the example of FIG. 2, in the engaged position.

FIG. 5 shows in partial side view the example of FIG. 2, in the released position.

FIG. 6 shows in transverse cross-sectional view an ejection module according to a first example of the presently disclosed subject matter.

FIG. 7(a) shows in front isometric view, and FIG. 7(b) shows in back isometric view, a tool useful with the example of the ejection module of FIG. 7.

FIG. 8 illustrates forces and moments acting on the example of FIG. 4.

### DETAILED DESCRIPTION

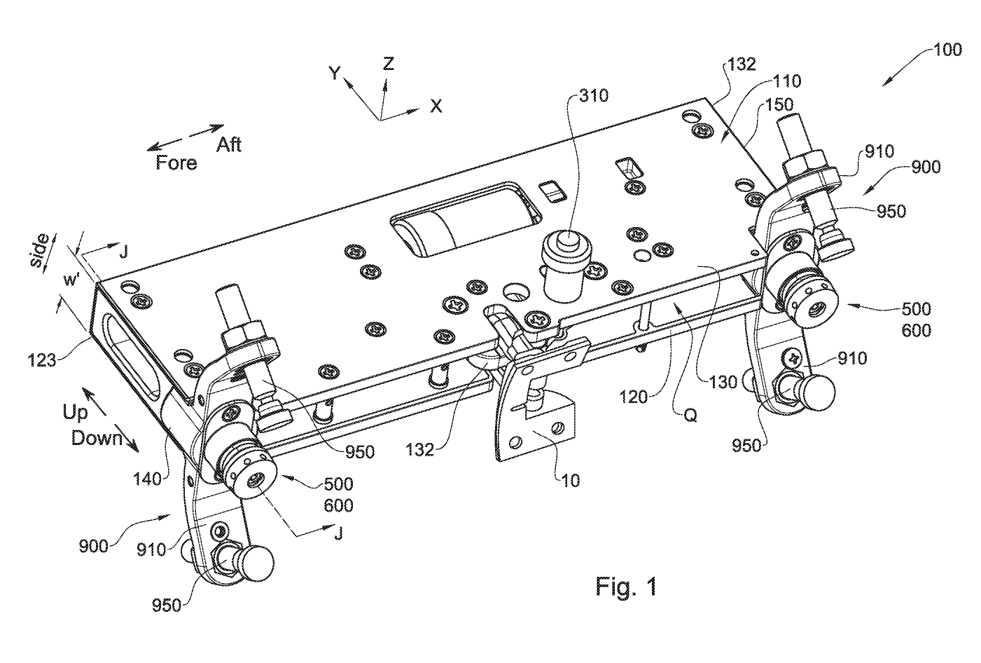

Referring to FIGS. 1 to 5 a suspension and release device according to a first example of the presently disclosed subject matter, generally designated 100, comprises a lug release system 300 and an ejector system 500.

In the Figures, the directional designations “Fore”, “Aft”, “Side”, “Up” and “Down” are shown, together with an arrow for each designation, to facilitate comprehension. Referring to an orthogonal axes system (x-y-z), the fore and aft directions are parallel to a longitudinal axis “x”; the side directions are parallel to the lateral axis “z”; the up and down directions are parallel to the vertical axis “y”. However, it is to be noted that the above directional designations are for ease of comprehension and are not necessarily limiting.

The suspension and release device 100 finds particular application in the form of an ejector rack (and is thus interchangeably referred to herein as an ejector rack, or as a stores ejector rack, or as a rack), for carrying a store, on or in an air vehicle. According to a first aspect of the presently disclosed subject matter, the suspension and release device 100 is configured for carrying the store in suspended configuration, and for selectively releasing the store from the air vehicle. According to a second aspect of the presently disclosed subject matter, the suspension and release device 100 is optionally configured forcibly ejecting the store away from the device 100 and thus away from the air vehicle.

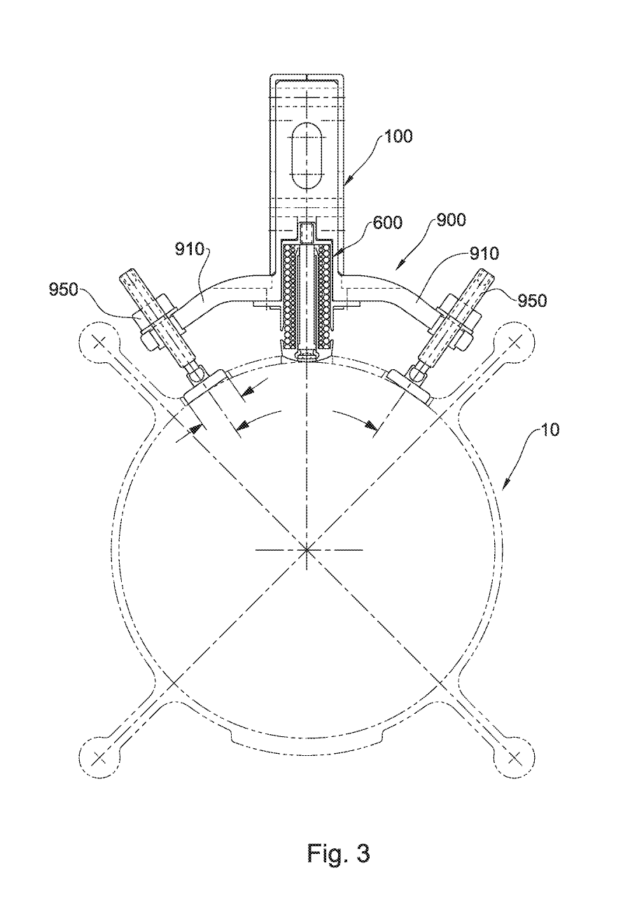

For example, such a store can be a bomb, missile, rocket, external fuel tank, and so on, and an example thereof is illustrated in FIG. 3 and designated with the reference numeral 10. The store 10 is in any case characterized in being equipped with at least one lug 15, by which the store 10 is releasably engaged to and suspended from, i.e., with respect to, the device 100. In this example, the store 10 has a single lug 15, and thus the device 100 only requires a single lug release system 300, as will become clearer herein. However, in alternative variations of this example, the store may instead have several lugs, and the suspension and release device can correspondingly comprise a similar number of lug release mechanisms 300, for example

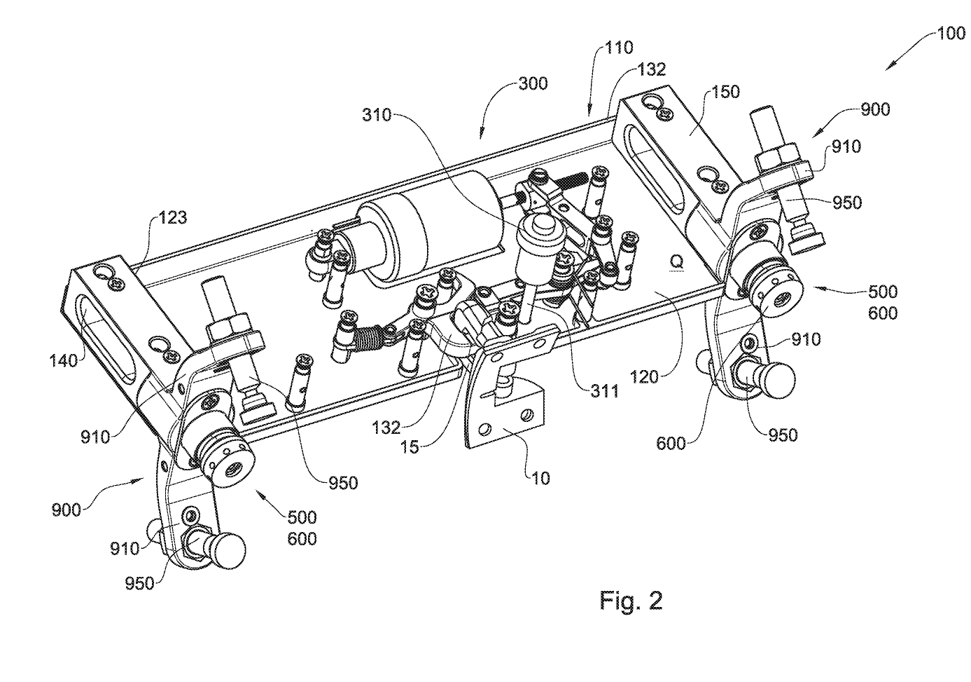

Referring to FIGS. 1 and 2 in particularly, the device 100 comprises a housing 110, including two parallel laterally spaced side plates (also referred to interchangeably herein as side walls or side panels) 120, 130, connected at the longitudinal ends 123, 132 thereof to end forward end block 140 and aft end block 150, respectively to form a box-like structure. A bottom plate (not shown) can be provided between the lower edges of the two side plates 120, 130, having an opening in registry with hook element 320, to enable a lug 15 of the store (not shown in FIGS. 1 and 2) to be inserted from outside the device 100 into the space Q between the side plates 120, 130 and engage vertically with hook element 320.

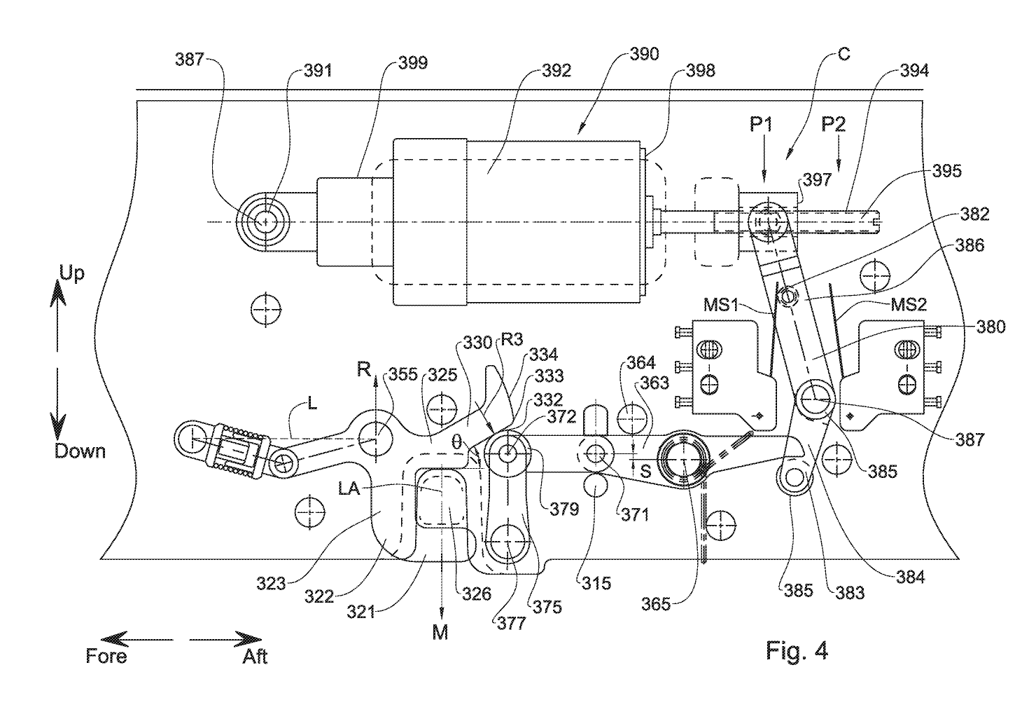

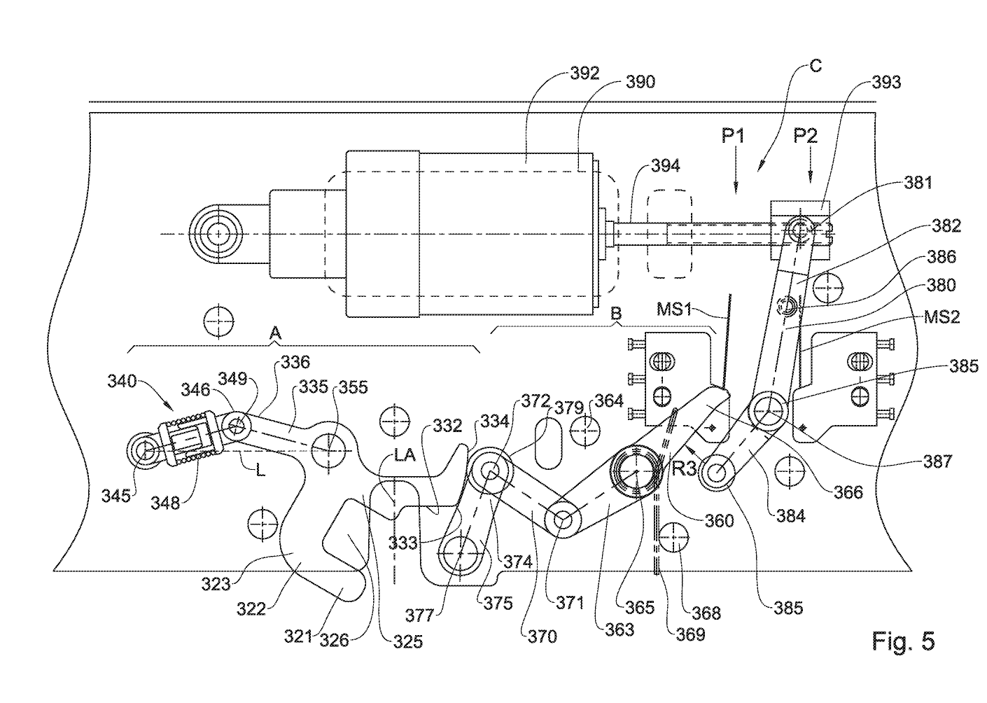

The housing 110 accommodates lug release system 300. Referring to FIGS. 4 and 5, lug release system 300 comprises hook element 320 pivotably connected to stressed link 340.

The hook element 320 is pivotably mounted between side plates 120, 130 to allow pivoting thereof about lateral pivot axis 355. The pivot axis 355 is fixed with respect to the housing 110.

Hook element 320 comprises a C- or U-shaped engagement portion 322, defined by lower arm 321, base 323 and upper arm 325, which together partially circumscribe a space 326. The lower arm 321 is generally parallel to the upper arm 325, and facing in a general aft direction, and pivot axis 355 is located proximal to the connection between the upper arm 325 and the base 323. The upper arm 325 has an arm extension 330 that projects generally aft from upper arm 325. The extension 330 comprises a first abutment surface 332 and a second abutment surface 334, generally orthogonal to one another, and joined together via a rounded lateral edge 333.

Hook element 320 further comprises an arm 335 of fixed length and extending generally forward, radially from the pivot axis 355, at an acute angle θ with respect to the upper arm 325. The free end 336 of arm 335 is pivotably connected to stressed link 340 at its free end 346 via pin 349.

Stressed link 340 is pivotably mounted between side plates 120, 130 to allow pivoting thereof about lateral pivot axis 345, which is fixed with respect to the housing 110. The free end 346 of the link 340 is reciprocably displaceable in a radial direction with respect to pivot axis 345. Stressed link 340 is pre-stressed, comprising a pre-stressed helical spring 348 that biases the free end 346 in a direction towards pivot axis 345.

In alternative variations of this example the helical spring 348 can be replaced with a two or more than two spring elements, in each case each spring element being for example a helical spring or any other suitable spring capable of storing elastic potential energy when compressed.

Thus, a first kinematic chain A is provided by the stressed link 340 and the hook element 320, having two stable relative positions that minimize the potential energy of the spring 348, and in which the pin 349 is at a maximum distance from an imaginary line L joining the pivot axis 345 and the pivot axis 355.

The first stable position is illustrated in FIG. 4, in which the pin 349 is below line L, and in which the hook element 320 is rotated counter clockwise to the closed or engaging position, enabling engagement of a lug.

The second stable position is illustrated in FIG. 5, in which the pin 349 is above line L, and in which the hook element 320 is rotated clockwise to the open or releasing position, enabling release of a lug previously engaged thereto.

The first kinematic chain A essentially thus operates as a lug engagement and release mechanism.

In the absence of external forces, the first kinematic chain A will adopt and remain at one of the two stable positions, until forced away from this stable position and past line L in proximity to the other stable position, wherein it will adopt and remain at the second stable position, and vice versa.

In order to load and engage a store, the first kinematic chain A must be in the second stable position shown in FIG. 5, allowing the lug to be vertically inserted into the bottom of housing 110 along vertical axis LA. As the lug (not shown in this figure) is thus inserted and pushes against the upper arm 325, hook element 320 rotates in a counter clockwise direction about pivot axis 355 to the first stable position shown in FIG. 4, causing the lower arm 321 to enter into the lug and come into load supporting contact therewith, the lug being accommodated in space 326.

The lug release system 300 further comprises a second kinematic chain B, defined by anvil 360, first link 370 and second link 375. The second kinematic chain B operates as a locking and unlocking mechanism for the first kinematic chain A.

Anvil 360 is pivotably mounted between side plates 120, 130 to allow pivoting thereof about lateral pivot axis 365, which is fixed with respect to the housing 110. The free end 366 of the anvil 360 projects in a general aft direction, generally radially from the pivot avis 365. The anvil 360 further comprises arm 363, fixed thereto and projecting radially away from pivot axis 365 in a direction generally opposed to that of free end 366, and arm 363is freely pivoted to one end of first link 370 at pin 371. The other end of first link 370 is freely pivoted to free end 374 of second link 375 at pin 372. In turn, second link 375 is pivotably mounted between side plates 120, 130 to allow pivoting thereof about lateral pivot axis 377, which is fixed with respect to the housing 110. A roller 379 is freely rotatable about pin 372 (i.e. about a lateral axis defined at pin 372), and in operation of the device 100, the roller 379 is in abutting contact alternately with first abutment surface 332 or second abutment surface 334.

The anvil 360 further comprises a torsion spring 369, having one end abutting a mechanical stop 368 in housing 110, and another end looped over free end 366. Torsion spring 369 biases free end 366 in a downward direction when in the position illustrated in FIG. 4, when the anvil 360 is pivoted in a clockwise direction until the arm 363 abuts mechanical stop 364, wherein the free end 366 and the arm 363 are in a general horizontal disposition. At this position, the kinematic chain B compels second link 375 to adopt a generally orthogonal orientation with respect to second link 375, which is generally aligned with arm 363.

At this position, corresponding to the first stable position of the first kinematic chain A, the roller 379 is in abutting contact with first abutment surface 332. Furthermore, the weight of the store as channeled by the lug and acting along axis LA, is supported at two points, each on either side of axis LA—at pivot axis 355 and at roller 379, providing a stable configuration.

The force R3 applied by abutment surface 332 on roller 379 (by virtue of the weight M of the store acting on arm 321) would try to urge pin 371 in an upward direction to collapse the second kinematic chain B and drive roller 379 away from axis LA. In fact, and as seen in FIG. 4, the centre of pin 371 is vertically displaced upwards by a displacement S with respect to pivot axis 365 by virtue of this force R3, but further upward displacement is prevented by mechanical stop 364.

Thus, mechanical stop 364 effectively locks the first kinematic chain A and the second kinematic chain B together, mechanically, in a geometrical lock, when in the position shown in FIG. 4. At the same time, undesired motion of the pin 371 in a downward direction to collapse the second kinematic chain B and thereby drive roller 379 away from axis LA is prevented by the biasing of torsion spring 369. For example, such undesired motion may arise from sudden knocks or vibration.

In this position, the first kinematic chain A is stably locked with respect to the second kinematic chain B in a load bearing and engaged configuration with the lug, until anvil 360 is rotated in a counter clockwise direction. This is enabled by selective operation of actuator mechanism C, via bellcrank 380.

Actuator mechanism C, which is also comprised in lug release system 300, comprises actuator 390 operatively coupled to the bellcrank 380.

Bellcrank 380 is pivotably mounted between side plates 120, 130 to allow pivoting thereof about lateral pivot axis 387, which is fixed with respect to the housing 110. Bellcrank 380 comprises a long arm 382 radially extending therefrom in a generally vertical direction, and the free end 381 of long arm 382 is pivotably coupled to shuttle 393 about a lateral pivot axis. Bellcrank 380 further comprises a short arm 384 radially extending therefrom in a direction generally opposed to the long arm 382 and disposed with respect thereto at an obtuse angle in this example The free end 383 of short arm 384 comprises a roller 385, which faces free end 366 in the closed position illustrated in FIG. 4.

The actuator 390 comprises a motor 392 having opposite longitudinal ends, 398, 399. The actuator 390 further comprises a shaft 394 rotatable by the motor 392 about a longitudinal axis 395, and connected to the motor 392 at aft end 398 of the motor 392. The actuator 390 is pivotably mounted between side plates 120, 130 to allow pivoting thereof about lateral pivot axis 387, which is fixed with respect to the housing 110. In particular, motor 392 is pivotably mounted to the housing 110 at a forward end 399 of the motor 392 via pin 391. In this example, the motor 392 is an electrical motor.

Shuttle 393 is mounted to the shaft 394, and is configured for reciprocably translating along longitudinal axis 395 alternately in a fore or aft direction, responsive to the motor turning in a clockwise or anticlockwise direction, respectively (or vice versa). In this example, the shaft 394 is formed with an external helical thread, while the shuttle 393 comprises a longitudinal bore 397 to allow sliding motion of the shaft 394 therethrough, and further includes at least one engagement pin (not shown) radially projecting towards the longitudinal axis 395 from the cylindrical inner surface of the bore 397. The engagement pin is engaged in the helical thread and thus as the shaft rotates about longitudinal axis 395 in a clockwise or counter clockwise direction, the engagement pin, together with the shuttle 393 moves correspondingly forward or aft (or vice versa).

In alternative variations of this example, the actuator can instead comprise a piston housing replacing motor 392, and a piston rod reciprocably movable along longitudinal axis 395 with respect to the piston housing, via an opening at an aft end of the piston housing; piston housing is pivotably mounted to the housing at a forward end of the piston housing. In such an example, the piston rod is driven by any suitable driving mechanism, for example a linear (electric) motor, a hydraulic mechanism, a pneumatic mechanism, and so on. In such a case, the shuttle 393 is fixed to the piston rod, and is reciprocably translated along longitudinal axis 395 in a fore or aft direction, responsive to the piston being moved out of or into the piston housing.

The lug release system 300 is configured for displacing the shuttle 393 between a forward position P1 and an aft position P2. In the forward position P1 shown in FIG. 4, roller 385 faces free end 366 and can actually be in contact therewith or spaced therefrom by a small clearance. However, at position P1, no force or no significant force is applied by the roller 385 onto free end 366.

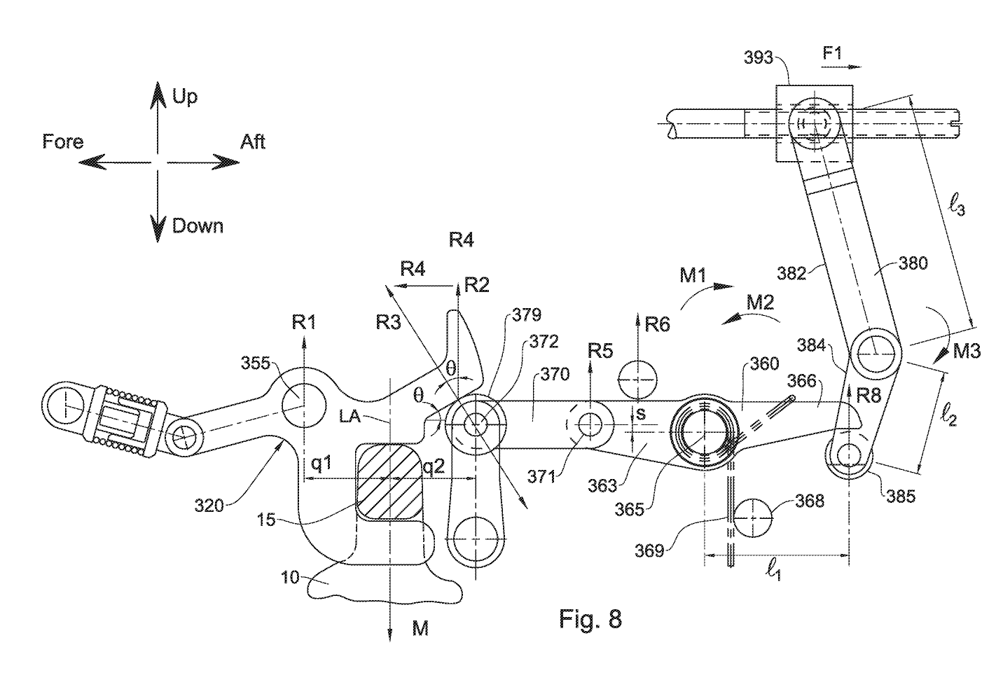

On the other hand, as the shuttle 393 is displaced from forward position P1 to aft position P2, responsive to operation of the motor 392, the bellcrank 380 is pivoted in a clockwise direction. The short arm 384 is moved towards the anvil 360, and a significant force R8 (FIG. 5) is now applied by the roller 385 onto the free end 366, the force being in or having a force component in the general upward direction. In turn, this force or force component induces a moment M2 (FIG. 8) onto the anvil 360 about pivot axis 365, causing the anvil 360 together with arm 363 to rotate in a counter clockwise direction about pivot axis 365. This counter clockwise rotation of arm 363 in turn pushes pin 371 downwards and away from mechanical stop 364. When the centre of pin 371 is pushed below the level of pivot axis 365, the second kinematic chain B become unlocked, and force R3 acting on roller 379 pushes roller 379 away from axis LA. Concurrent with this movement, the first kinematic chain A also becomes unlocked, and the hook element 320 can now rotate in a clockwise direction about pivot axis 355, since the weight M is no longer being effectively supported at the roller 379. As this movement continues and second link 375 rotates in a clockwise direction about pivot axis 377, the roller 379 moves along first abutment surface 332 and then, via edge 333, onto the second abutment surface 334; concurrently, as the hook element 320 continues to rotate the weight M overcomes the pre-stress of the spring 348 and allows the second stable position to be attained (FIG. 5). At this point the lower arm 321 is completely removed from the lug 15, which is then released and is free to fall away from the device 100 by gravity, and/or is forcibly ejected by use of the ejection system 500.

In the second stable position of the first kinematic chain A, the second kinematic chain B is locked in the position shown in FIG. 5, and cannot be operated in order to achieve the configuration of FIG. 4, except by inserting another lug along axis LA and pushing upper arm 325, as already described above. While in the second, locked, position of FIG. 5 the torsion spring 369 is stressed, there is insufficient potential energy therein to cause the second kinematic chain B to become unlocked and urge the anvil 360 in a downward direction, due to the force applied to second kinematic chain B by the spring 348 and via the second abutment surface 334. However, once the second kinematic chain B is unlocked (by engaging a lug) the torsion spring 369 urges the anvil 360 in a downward direction towards the position shown in FIG. 4, displacing pin 371 to spacing S and into abutment with mechanical stop 364, and thereby again locking the first kinematic chain A and the second kinematic chain B together.

It is to be noted that once the short arm 384 has rotated sufficiently so that, via abutment with anvil 360 and rotation of arm 363, the pin 371 is below the pivot axis 365, there is no further need to apply force R8 to the free end 366, and further rotation of the anvil 360 and arm 363 is now compelled by force R3 (FIG. 4). Accordingly, the bellcrank 380 can be pivoted back to the starting position of FIG. 4 as soon as pin 371 is below the pivot axis 365, or shortly after. This is accomplished by actuating the motor 392, which then turns shaft 394 in the opposite direction, thereby displacing shuttle 393 in a forward direction back to first position P1.

Operation of lug release system 300 to pivot back the bellcrank 380 is facilitated in this example by providing a first microswitch MS1 and a second microswitch MS2, operatively coupled to the motor 392, and a mechanical stop 386 provided on and carried by the long arm 382.

The first microswitch MS1 is configured for switching off the motor 392 when contacted by mechanical stop 386, while the second microswitch MS2 is configured for reversing the direction of rotation of the motor 392 when contacted by mechanical stop 386.

Operation of the device to engage a store 10 is as follows. Starting with the first kinematic chain A and the second kinematic chain in the positions shown in FIG. 5, and the actuator mechanism C in the position shown in FIG. 4, a store 10 can be engaged by inserting the lug 15 thereof in an upward direction into device 100 along axis LA, and pushing upper arm 325. This forces the first kinematic chain A into the first stable position illustrated in FIG. 4. Concurrently, and as the hook element 320 is rotated about pivot axis 355, roller 379 contacts second abutment surface 334, urged by torsion spring 369 acting on anvil 360, until the pin 371 is in abutment with mechanical stop 364, thereby locking the first kinematic chain A and the second kinematic chain in the positions shown in FIG. 4. At this position, the lug is engaged by hook element 320, and in loading relationship with the first kinematic chain A and the second kinematic chain.

The device 100 optionally comprises a removable safety lock 310 (FIGS. 1 and 2) that is selectively and releasably engageable with respect to the housing 110 for safety locking the first kinematic chain A and the second kinematic chain B. Safety lock 310 comprises a pin 311 that is insertable into housing 110 via opening 315 (FIG. 4), i.e., at a position that is disposed just below the position of pin 371 in the position shown in FIG. 4, and thus prevents downward motion of the pin 371. Thus, when the safety latch 310 is in place engaged in opening 315, any accidental unlocking of the second kinematic chain B is prevented until the safety lock 310 is removed.

Operation of the device to release a store 10 is as follows. Starting with the first kinematic chain A, the second kinematic chain B, and actuator mechanism C in the positions shown in FIG. 4, the engaged store 10 can be released by selectively activating the actuator mechanism C.

Initially, in the configuration shown in FIG. 4, the motor 392 is off until the actuator mechanism C is actuated by a user, for example using circuitry (not shown) that is activated when it is desired to operate the device 100 and allow the lug and stores to be released. Such actuation causes the motor to rotate shaft 394 in one rotational direction such as to displace the shuttle 393 towards the second position P2. Concurrently, bellcrank 380 is rotated in a clockwise direction, unlocking the first kinematic chain A and the second kinematic chain B, allowing hook element 320 to rotate in a clockwise direction to the position shown in FIG. 5, thereby releasing the lug and stores.

Once the shuttle 393 reaches position P2, the mechanical stop 386 activates the second microswitch MS2, which automatically reverses the rotational direction of the motor 392 (and thus of the shaft 394), causing the shuttle 393 to become displaced again in a forward direction, and allowing the bellcrank 380 to adopt the position showing in FIG. 5 when the shuttle reaches position P1. However, at position P1, mechanical stop 386 activates the first microswitch MS1, which automatically shuts off the motor 392 and maintains the shuttle 393 at position P1 until the next time the actuator mechanism C is selectively actuated by the user.

According to the first aspect of the presently disclosed subject matter, the lug release system 300 functions as a toggle mechanism, wherein a relatively small force applied by the motor 392 operates to release a much larger force supported by the hook element 320 (i.e., the weight M of the stores via the lug).

In particular, locking and unlocking mechanism is configured to function as a toggle mechanism, wherein a relatively small force applied thereto (in this example by the torsion spring) maintains it at the locked position while concurrently enabling a much larger force corresponding to the load or weight M of the stores to be resisted by the locking and unlocking mechanism. In particular, the locking and unlocking mechanism is configured to form a geometrical lock, when part of the weight M is supported thereby, the weight M actually maintaining the geometrical lock, constrained in this configuration by the weight M and by mechanical stop 364. In other words, the locking and unlocking mechanism provides a geometrical lock in the locked configuration of FIG. 4.

Referring also to FIG. 8, and without being bound to theory, the geometrical lock provided by the locking and unlocking mechanism also enables a relatively large force (e.g. the weight M of the stores 10) to be supported by the locking and unlocking mechanism (via the hook element 320), and enables a much smaller actuating force F1 to unlock the locking and unlocking mechanism and thereby release the stores 10.

As may be seen in FIG. 8, the weight M of the engaged stores 10 is supported via vertical reaction R1 at pivot axis 355 and vertical reaction R2 at pivot axis 372 (via roller 379). Reactions R1 and R2 are approximately equal to one another, since the longitudinal spacings, q1 and q2 respectively, of these two axes with respect to vertical axis LA are approximately equal. Thus, the vertical reaction R2 is about 50% of weight M (and in some examples ±10%). (However, in alternative variations of this example the weight M can be asymmetrically supported: for example R2 can have a value between 10% and 90% of M, or a value between 20% and 80% of M, or a value between 30% and 70% of M, or a value between 40% and 60% of M.)

The vertical reaction R2 is a component of the total reaction R3 provided radially at roller 379 through pivot axis 372, and total reaction R3 also resolves to a horizontal reaction R4. Reaction R4 can be determined from the vertical reaction R2 using the following expression:

R4=R2*tan

Angle θ is the angle between the total reaction R3 and the vertical reaction R2, and in this example, angle θ is about 30°.

Thus, reaction R4 is about 58% of R2, i.e. about 29% of weight M. Reaction R4 provides a moment M1 about pivot axis 365 that urges arm 363 against mechanical stop 364, and moment M1 can be determined from the expression:

M1=R4*S

In order to unlock the locking and unlocking mechanism, and thus allow the hook element 320 to released the lug 15 with stores 10, force R8 is provided via bellcrank 380 and applied to anvil 366 to generate a counter moment M2, just greater than moment M1, but in the opposite direction.

Moment M2 can be determined from the expression:

M2=R8*l₁

. . . where l₁ is the moment arm of force R8 (at the tangential contact point between roller 385 and anvil 366) from the pivot axis 365.

Thus, a minimum value for force R8 is determined from the expression:

R8=R4*(S/l₁)

Or,

R8=0.29M*(S/l₁)

For example, in one application, S is 0.8 mm, while l₁ is about 15 mm, and thus the ratio (S/l₁) is 0.0533, and thus R8 is about 1.5% of the weight M.

In practice, R8 needs to be even greater than this minimum value to also overcome the reaction to the unlocking moment M2 provided by torsion spring 369. In practice, torsion spring 369 provides a safety measure in preventing accidental unlocking of the locking and unlocking mechanism due to sudden knocks or vibrations, and thus does not need to develop large forces.

Force R8 is in turn generated via moment M3 corresponding to the actuating force F1, generated by the actuator and shuttle 393, acting on bellcrank 380, and the two forces, F1, R8, are related to one another by their respective moment arms l₂ and l₃, respectively; thus:

F1=R8*(l₂/l₃)

Or,

F1=0.29M*(S/l₁)*(l₂/l₃)

In the above example, wherein ratio (S/l₁) is 0.0533, and for example the ratio (l₂/l₃) is about 2, the actuating force F1 is less than 1% of the weight M supported by the hook element 320 (excluding the effect of torsion spring 369).

It is also to be noted that once the force R8 is applied to the anvil 366, and this pivots over a small angular displacement about pivot axis 365 sufficient to diminish spacing S to zero, the locking and unlocking mechanism is no longer in geometrical lock. Thus, force R8 no longer needs to be applied to the anvil 366 by bellcrank 380, which can immediately pivot back to the position shown in FIG. 4, and this is facilitated by operation of microswitches MS1 and MS2. Instead, once the pin 371 is below the level of pivot axis 365, the reaction R4 produces a moment about pivot axis 365 that is in the opposite direction to moment M1, and thus the locking and unlocking mechanism is not able to provide reaction R2 to support weight M. Accordingly, the moment provided by the weight M about pivot axis 355 drives the hook element 320 to pivot about pivot axis 355, thereby opening and releasing the lug 15 and with it stores 10.

Referring to FIGS. 1, 2, and 3, the device 100 in this example further comprises two sway brace assemblies 900. One sway brace assembly 900 is provided at a forward end of the device 100 and can be affixed to the forward end block 140, while the other sway brace assembly 900 is provided at the aft end of the device 100 and can be affixed to aft end block 150. The sway brace assemblies 900 can be used for controlling movement or vibration of the stores 10 when engaged by the device 100, while not interfering with the engagement procedure or the release procedure of the stores with respect to the device 100.

Each brace assembly 900 comprises a pair of lateral flanges 910, each flange 910 carrying a sway brace 950 at each end thereof having an abutment end which in operation of the device is in abutting contact with the stores when the stores is engaged by the device 100. In some applications of the device 100 one or more of the sway brace assemblies 900, or at least one or more of the sway braces 950 can be omitted.

The device 100 can be operated absent the ejector system 500, and thus allows the stores to drop away therefrom under the influence of gravity once released from the hook element.

According to a second aspect of the presently disclosed subject matter, the suspension and release device 100 is optionally configured for forcibly ejecting the store away from the device 100 and thus away from the air vehicle. Thus, alternatively, and optionally, the device 100 can be operated together with ejector system 500, configured for forcibly ejecting the store away from the device 100 and thus away from the air vehicle, once the stores is released from the device 100.

The ejector system 500 comprises at least one ejection module 600 configured for forcibly ejecting a store away from the device 100. In particular, each ejection module 600 is configured for providing an ejection force generated via release of stored elastic potential energy.

In this example, the ejector system 500 comprises two ejection modules 600, which are essentially identical to one another, and thus, only one shall be described herein. In alternative variations of this example, the ejector system 500 can instead comprise one or more than two ejection modules 600. In this example each ejection module 600 is accommodated in one or the other of forward end block 140 or aft end block 150 (FIGS. 1 and 2).

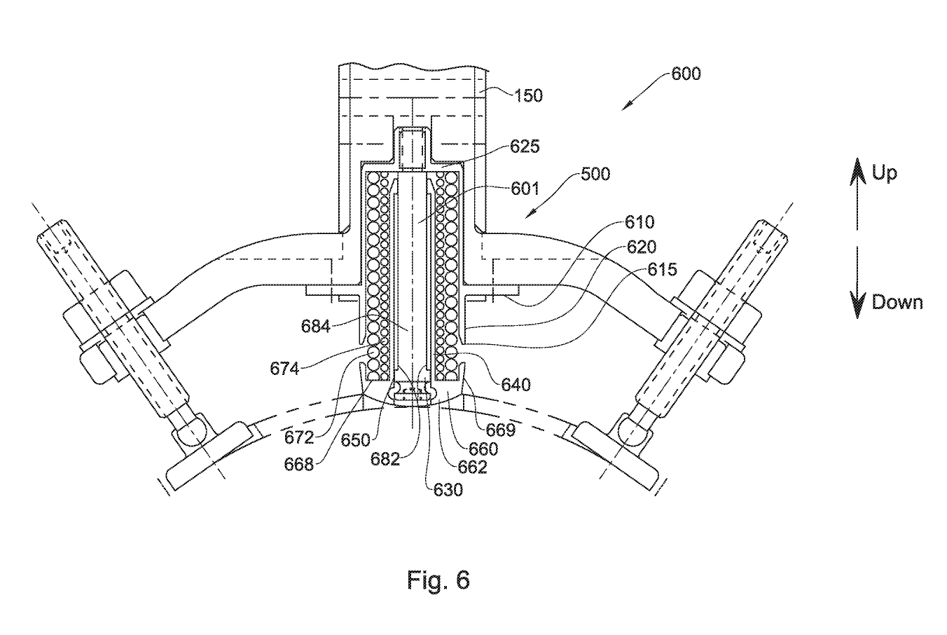

Referring to FIGS. 6 in particular, a first example of ejection module 600 according to the second aspect of the presently disclosed subject matter, comprises a tubular housing 620, extending along a longitudinal axis 601. The tubular housing 620 is open at one longitudinal end 615 thereof and closed at a second longitudinal end 625 thereof. A guiding pin 630, co-axial with longitudinal axis 601, is fixed at the closed end 625 and extends therefrom and projects beyond the open end 615. A plunger element 640 comprises a hollow shaft 650, coaxial with guiding pin 630 and slidably mounted thereto, and an abutment element 660. Abutment element 660 comprises a padded outer end 662, an annular shoulder 668, and annular lip 669. Two concentric helical springs 672, 674, co-axial with longitudinal axis 601, are abutting said shoulder 668 at one end thereof and said closed end 625 at the other end thereof.

In alternative variations of this example the pair concentric helical springs 672, 674 can be replaced with a single spring element, or with more than two spring elements, in each case each spring element being for example a helical spring or any other suitable spring capable of storing elastic potential energy when compressed.

Tubular housing 620 comprises a flange 610 configured for affixing the ejection module 600 to the device 100, in particular to one or the other of forward end block 140 or aft end block 150.

The plunger element 640, via the hollow shaft 650, is slidable about guiding pin 630 and along longitudinal axis 601, between an extended position and a retracted position. In the extended position the abutment element 660 is at a maximum spacing from closed end 625, and springs 672, 674 are unstressed or have a minimum compressive stress. In the retracted position the abutment element 660 is at a minimum spacing from closed end 625, and springs 672, 674 are at maximum compressive stress, in which the springs 672, 674 store elastic potential energy. The plunger element 640 can be pushed towards the closed end 625 to any one of a plurality of relative positions one with the other, at each position the elastic potential energy stored by springs 672, 674 will be closer to that corresponding to the maximum compressive stress or the minimum compressive stress depending on whether the position is closer to the retracted position or the extended position. One or more holes 682 are provided on hollow shaft 650, while a series of circumferential cutouts or channels 684 are provided in the guiding pin 630 and longitudinally spaced from one another. As the plunger element 640 is pushed towards the closed end 625 to any one of said plurality of relative positions, holes 682 become aligned with a corresponding one of the channels 684, and a removable locking pin (not shown) can be inserted through the one or more holes 682 and the particular channels 684 in registry therewith to hold the plunger element 640 at this position. In operation of the device 100, such a position corresponds to the abutment element 660 being in abutment with the outer surface of the stores 10 when the stores is engaged by the device 100, for example as indicated in FIGS. 3 and 5. While in this example, the tubular housing 620 and hollow shaft 650 are cylindrical, in alternative variations of this example the casing and hollow shaft can each have any other suitable cross-section.

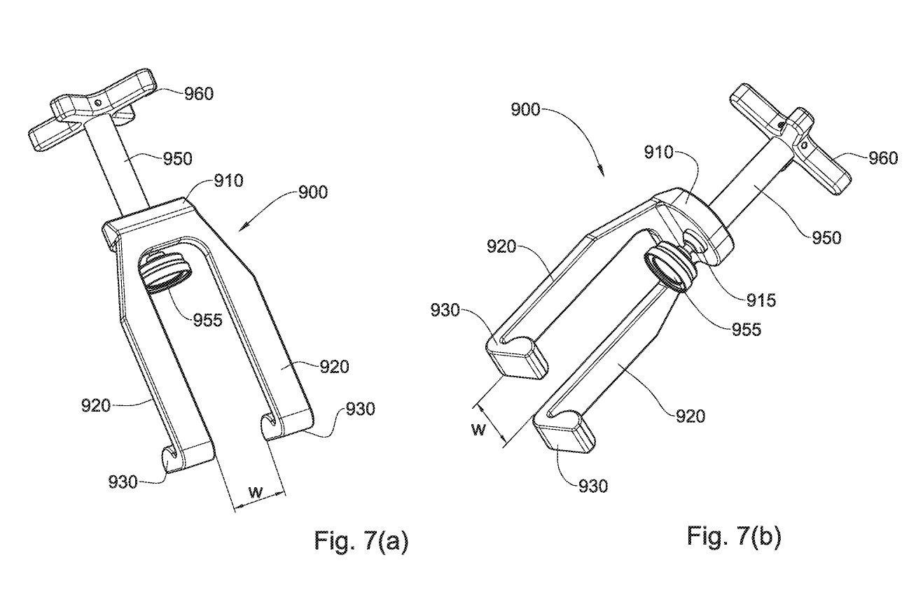

Referring to FIGS. 7(a) and 7(b), a retraction tool 900 can be employed to provide the desired retraction of the plunger element 640.

Retraction tool 900 comprises a base 910 having a threaded bore 915 coupled to a leadscrew 950. A pair of arms 920 are orthogonally joined to base 910 at one end thereof, and comprise hook projections 930 at another end thereof. In side view, each combination of hook projection 930, arm 920 and base 930 has a C-like form. An abutment head 955 is provided at one end of the leadscrew 950, between the base 910 and the hook projections 930, while a turning handle 960 is provided at the other end of the leadscrew 950. Turning the leadscrew 950 via the handle 960 in one direction advances the abutment head 955 towards hook projections 930, while turning the handle 960 in the opposite direction distances the abutment head 955 from hook projections 930. The two arms 920 are laterally spaced at a spacing W, greater than the width W′ of the housing 110 (see FIG. 1) but less than the width of the flanges 910.

In use, the tool 900 can be engaged to the forward or aft end of the device 100, such that the hook projections 930 are abutting the top of the corresponding flanges 910, and the abutment head 955 is in contact with the respective abutment element 660. The handle 960 is then turned to retract the plunger element 640, and when the required relative position is reached with respect to the tubular housing 620, a locking pin is inserted between the holes 682 and the particular channels 684 in registry therewith to hold the plunger element 640 at this position. The tool 900 can then be removed, and the operation repeated with the other ejection modules 600. In this position, the ejection modules 600 are pre-stressed, wherein the respective springs 672, 674 are compressed and storing elastic potential energy.

At this point the stores 100 can be engaged to the device 100 via the lug 15, as already disclosed above. Once engaged, the locking pins can be removed, and the ejection modules 600 are maintained in their respective pre-stressed states since the stores is pressing against the respective abutment elements 660 by virtue of the engagement of the stores to the device 100.

However, once the stores are released from the device 100 by disengagement of the lug 15 from the lug release system 300, the stored elastic potential energy in the springs 372, 374 urge the respective plunger elements 640 away from their respective casings 610 and thus forcibly eject the stores (onto which the plunger elements 640 abut) away from the device 100.

It is to be noted that while the ejector system 500 and ejection module 600 have been described in the context of the example of device 100, in alternative variations of this example, the ejector system 500 and ejection module 600 can instead be used with different types of suspension and release devices, for example conventional devices known per se in the art.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the spirit of the presently disclosed subject matter.

1. An ejector rack for releasably supporting a store, the store having at least one lug for enabling removable engagement of the store with the ejector rack, the ejector rack comprising:
a housing, including:
a lug engaging and releasing mechanism configured for selectively and releasably engaging the lug, and movable between a lug engaging position and a lug releasing position;
a locking and unlocking mechanism actuable between a locking position, for reversibly locking said lug engaging and releasing mechanism in said lug engaging position, and an unlocking position, for enabling the lug engaging and releasing mechanism to adopt said lug releasing position;
an actuation system for reversibly actuating said locking and unlocking mechanism;
wherein the locking and unlocking mechanism is configured, in operation of the ejector rack, for supporting part of a load applied by the store via the lug to the lug engaging and releasing mechanism in said lug engaging position.

2. An ejector rack according to claim 1, wherein in the lug engaging position the lug engaging and releasing mechanism is in load bearing contact with the locking and unlocking mechanism.

3. An ejector rack according to claim 1 or claim 2, wherein in the locking position said locking and unlocking mechanism are geometrically locked via the load.

4. An ejector rack according to any one of claims 1 to 3, wherein said lug engaging and releasing mechanism comprises a first kinematic chain, comprising a stressed link pivotably connected to a hook element via a first pin, wherein the stressed link is further pivotably mounted to said housing at a fixed first pivot axis, and the hook element is pivotably mounted to the housing at a fixed second pivot axis.

5. An ejector rack according to claim 4, wherein said hook element comprises a C- or U-shaped engagement portion, configured for engaging said lug when pivoted about the second pivot axis to an engagement position, and for disengaging from the lug when pivoted away from the engagement position to a released position, the hook element further comprising an extension having a first abutment surface and a second abutment surface generally inclined to one another, and joined together via a rounded lateral edge, the extension projecting in a direction towards the locking and unlocking mechanism.

6. An ejector rack according to claim 4 or claim 5, wherein said stressed link comprises a free end at said first pin, said free end being reciprocably displaceable in a radial direction with respect to said first pivot axis, and wherein said stressed link is pre-stressed to bias said free end in a direction towards said first pivot axis.

7. An ejector rack according to any one of claims 4 to 6, wherein said first kinematic chain operates to provide a first stable position and a second stable position, different from said first stable position, wherein in each one of said first stable position and said second stable position are such as to minimize a potential energy of said stressed link, and in which said first pin is at a respective maximum distance from an imaginary line joining said first pivot axis to said second pivot axis.

8. An ejector rack according to claim 7, wherein in said first stable position said first pin is on one side of said imaginary line, and said hook element is pivoted to the engagement position, enabling engagement of the lug, and wherein in the second stable position said first pin is side of said imaginary line and said hook element is pivoted in an opposed direction to the release position, enabling release of the lug if previously engaged thereto.

9. An ejector rack according to any one of claims 1 to 8, wherein said locking and unlocking mechanism is configured to function as a toggle mechanism, wherein a relatively small force applied thereto maintains said locking and unlocking mechanism at the locked position while concurrently enabling a much larger force corresponding to said load to be resisted by said locking and unlocking mechanism.

10. An ejector rack according to any one of claims 1 to 9, wherein said locking and unlocking mechanism comprises a second kinematic chain comprising: a first link pivotably connected to an anvil via a second pin and pivotably connected to a second link via a third pin, wherein said anvil pivotably is mounted to said housing at a fixed third pivot axis, and said second link is pivotably mounted to said housing at a fixed fourth pivot axis, and wherein said anvil is pre-stressed to provide said small force.

11. An ejector rack according to claim 9 or claim 10, wherein said anvil is pre-stressed by a torsion spring to provide said small force.

12. An ejector rack according to claim 10 or claim 11, comprising a roller freely rotatable about said third pin, and wherein said roller is in abutting contact alternately with said first abutment surface or said second abutment surface.

13. An ejector rack according to claim 12, wherein in said locking position, said engagement portion is in said engagement position, said roller is in abutting contact with said first abutting surface and in load bearing contact therewith, and capable of supporting said part of the load applied by the store via the lug, and wherein said anvil is prestressed to urge said second kinematic chain towards and abut a physical stop provided in the casing, in said locking position.

14. An ejector rack according to any one of claims 4 to 13, wherein a remainder of said load is supported at said first pin.

15. An ejector rack according to claim 14, wherein a remainder of said load is symmetrically supported at said first pin and at said roller.

16. An ejector rack according to any one of claims 13 to 15, wherein in said unlocking position, said anvil is selectively pivoted about said third pivot axis such that said second kinematic chain is urged away from said physical stop, sufficiently for the second kinematic chain to adopt a position that is not capable of supporting said part of the load applied by the store via the lug, enabling said roller to come into abutting contact with said second abutting surface while concurrently said engagement portion pivots to said release position, allowing release of the lug if previously engaged therein.

17. An ejector rack according to claim 16, wherein applying a pivoting force to said engagement portion by a lug to pivot the engagement portion to the engagement position automatically results in the second kinematic chain adopting the locking position.

18. An ejector rack according to any one of claims 1 to 17, wherein said actuation system for reversibly actuating said locking and unlocking mechanism comprises a bellcrank pivotably mounted to said housing at a fixed fifth pivot axis, the bellcrank having a long arm and a short arm each extending radially away from said fifth pivot axis, said actuation system further comprising an actuator coupled to said long arm and configured for selectively reversibly pivoting said bellcrank about said fifth pivot axis to thereby reversibly move said short arm between a first position and a second position, to thereby reversibly actuate said locking and unlocking mechanism.

19. An ejector rack according to claim 18, wherein moving said short arm between said first position and said second position causes said anvil to pivot about said third pivot axis such that said second kinematic chain is urged away from said physical stop, sufficiently for the second kinematic chain to adopt a position that is not capable of supporting said part of the load applied by the store via the lug.

20. An ejector rack according to any one of claims 18 to 19, wherein said actuation system comprises an electrically powered motor comprising a shaft turned thereby, and further comprising a shuttle pivotably mounted top said long arm and coupled to the shaft, such that rotation of the shaft in one or another direction causes displacement of the shuttle, resulting in pivoting of said bellcrank about said fifth pivot axis in one or another direction, respectively.

21. An ejector rack according to any one of claims 1 to 20, further for selectively ejecting forcibly the store therefrom, the ejector rack comprising an ejector system comprising at least one ejection module, each ejection module configured for storing elastic potential energy therein, and for utilizing the stored potential energy for forcibly ejecting the store when the store is released from the ejector rack.

22. An ejector rack according to claim 21, each ejection module comprising:
a plunger element reciprocably movable with respect to a casing and comprising at least one elastic element therebetween, the plunger element being selectively retractable with respect to the casing to any one of a plurality of retracted positions up to a maximum retracted position, wherein at each said position the at least one elastic element is progressively compressed storing therein said potential energy.

23. An ejector rack according to claim 22, wherein said at least one elastic element comprises at least one helical spring.

24. An ejector rack for releasably supporting, and selectively ejecting forcibly, a store therefrom, the store having at least one lug for enabling removable engagement of the store with the ejector rack, the ejector rack comprising an ejector system comprising at least one ejection module, each ejection module configured for storing elastic potential energy therein, and for utilizing the stored potential energy for forcibly ejecting the store when the store is released from the ejector rack.

25. An ejector rack according to claim 24, each ejection module comprising:
a plunger element reciprocably movable with respect to a casing and comprising at least one elastic element therebetween, the plunger element being selectively retractable with respect to the casing to any one of a plurality of retracted positions up to a maximum retracted position, wherein at each said position the at least one elastic element is progressively compressed storing therein said potential energy.

26. An ejector rack according to claim 25, wherein said at least one elastic element comprises at least one helical spring.

27. An air vehicle comprising at least one ejector rack as defined in any one of claims 1 to 26.

28. A method for releasably supporting a store, the store having at least one lug, the method comprising:
(a) providing at least one ejector rack as defined in any one of claims 1 to 26; and
(b) engaging the lug with respect to the lug engaging and releasing mechanism to thereby urge the locking and unlocking mechanism to the locking position.

29. A method according to claim 28, further comprising:
(c) selectively operating the actuation system to thereby actuate said locking and unlocking mechanism to enable the locking and unlocking mechanism to adopt the unlocking position, thereby enabling the lug engaging and releasing mechanism to release the lug therefrom.

30. A method according to any one of claims 26 and 27, wherein in step (b), a plurality of said ejection modules are in a pre-stressed condition and in abutment with the engaged stores.

31. A method according to claim 30, wherein in step (c) said plurality of said ejection modules forcibly eject the stores from the ejector rack.
